(19) United States
(12) Patent Application Publication
(10) Pub. No.: US 2019/0025666 A1
(43) Pub. Date: Jan. 24, 2019

(54) Systems and Methods for Light Field Generation

(71) Applicant: The Charles Stark Draper Laboratory, Inc., Cambridge, MA (US)

(72) Inventors: Steven J. Byrnes, Watertown, MA (US); Gregg E. Favalora, Bedford, MA (US); Ian Ward Frank, Arlington, MA (US); Anthony Kopa, Somerville, MA (US); Michael G. Moebius, Somerville, MA (US); Joseph J. Register, St. Petersburg, FL (US)

(21) Appl. No.: 16/041,028

(22) Filed: Jul. 20, 2018

Related U.S. Application Data
(60) Provisional application No. 62/534,866, filed on Jul. 20, 2017.

(51) Int. Cl. G02F 1/33; G02F 1/313; G03H 3/00

(52) U.S. Cl. CPC G02F 1/332; G03H 2225/60; G03H 3/00; G02F 1/3136

(57) ABSTRACT

A system and method for light field generation is disclosed. A proposed holographic display system encodes views of a scene into surface acoustic waves (SAW signals) that propagate along waveguides of SAW modulators and/or optical signals propagating in the waveguides. Each view provides a different perspective of the scene when the views are projected as light fields out of the SAW modulators and are viewed at different locations by an observer. In some examples, the system encodes the brightness information for each view into the light signals.

### RELATED APPLICATIONS

This application claims the benefit under 35 USC 119(e) of U.S. Provisional Application No. 62/534,866, filed on Jul. 20, 2017, which is incorporated herein by reference in its entirety.

### BACKGROUND OF THE INVENTION

Acousto-optic modulators (AOMs) show promise as components of light display systems for generating light fields as are required for holographic displays and other applications. One class of AOMs are termed surface acoustic wave (SAW) optical modulators. These modulators can provide controllable sub-holograms from which a light field can be constructed.

One type of SAW modulator is the guided-to-leaky-mode device fabricated using lithium niobate as described, for example, in Hinkov et al., Collinear Acoustooptical TM-TE Mode Conversion in Proton Exchanged Ti:LiNbO3 Waveguide Structures, J. Lightwave Tech., vol. 6(6), pp. 900-08 (1988), Smalley et al., Anisotropic leaky-mode modulator for holographic video displays, Nature, vol. 498, pp. 313-317 (2013), herein after “Smalley”; McLaughlin et al., Optimized guided-to-leaky-mode device for graphics processing unit controlled frequency division of color, Appl. Opt., vol. 54(12), pp. 3732-36 (2015), Qaderi et al., Leaky-mode waveguide modulators with high deflection angle for use in holographic video displays, Opt. Expr., vol. 24(18), pp. 20831-41 (2016), hereinafter “Qaderi”; and Savidis et al., Progress in fabrication of waveguide spatial light modulators via femtosecond laser micromachining, Proc. of SPIE Vol. 10115, 2017.

In these SAW modulators, surface acoustic waves (SAWs) diffract light propagating in the modulators' waveguides and cause at least some of the light to change from guided modes to leaky modes that exit the waveguides at angles dictated in part by the frequency of the light and the frequency of the SAWs.

Currently proposed SAW modulator-based holographic display systems generate holographic images from stored or computed representations of a 3D scene. Such systems can project still holographic images, or holographic video by translating each frame into electronic control signals for the display systems. The holographic images are typically encoded as one or more views of the scene in each frame, with a 2D image (brightness of each color component of each pixel) for each view. Each view corresponds by definition to a different angle of light emission from the display. As a result, a view dictates the exit angle of light from the display, and an observer will see one or more views of different pixels depending on the location of their pupils relative to the display, in a way that mimics some or all of the depth cues of a real 3D object.

In any event, the pixel brightness information for all the views in any one frame is encoded into light signals provided to the SAW modulators and/or radio frequency drive signals that are used to generate the SAWs in the modulators. Holographic display systems using SAW modulators sometimes require wave propagation cancellation between the light signals and the SAWs that co-propagate or counter propagate along the length of the waveguides. Wave propagation cancellation is required because the light signals and SAW are traveling waves that move through or adjacent to the waveguide, whereas the systems require an image that is stationary or moving in an arbitrary way. For example, a displayed point in a view may cover only half of a waveguide, such that the left side of the waveguide might need to emit light while the right side remains dark. However, the same SAW that would cause light to scatter from the left side of the waveguide will then travel to the right side of the waveguide, where it would cause undesirable scattering.

One undesirable outcome of unmitigated SAW propagation is image motion, which is usually perceived as image blur by an observer. For example, the acoustic velocity of a typical SAW in a lithium niobate substrate having an x-cut, y-propagating waveguide is 3,909 meters per second (m/s). Current approaches for accomplishing wave cancellation include descanning of the modulated light signals using spinning mirrors, and a “traditional strobe” modality that applies pulsed light signals to the SAW modulator.

The spinning mirror descanning is analogous to that used in 1930s era scophony television displays. See H. W. Lee, “The Scophony Television Receiver,” Nature, 142, 59-62 (9 Jul. 1938). When scophony-type scanning is applied to electro-holographic display, the light signals are applied as a continuous wave (CW) and a spinning polygonal mirror continually shifts the apparent location of the AOM modulator at an equal and opposite speed from the SAWs. While this works, it also typically requires thick form-factors and moving parts. Examples of descanning-based holographic displays include the “MIT Mark” series of prototypes. See St Hilaire, “Scalable optical architecture for electronic holography,” Optical Engineering 34(10), 2900-2911 (October 1995), and Smalley, Smithwick, and Bove, “Holographic video display based on guided-wave acousto-optic devices”, Proc. SPIE 6488, 64880L, 2007.

When employing the traditional strobe modality, the SAWs are created as one would in a descanning display (i.e. the ideal desired optical phase modulation pattern), but strobed light is used instead of continuous-wave (CW) illumination to accomplish the wave propagation cancellation. The pulses of the strobe light are timed consistent with the repetition rate of the SAW so that the SAWs appear to be stationary. For example, see Jolly et al., “Near-to-eye electroholography via guided-wave acousto-optics for augmented reality”, Proc. SPIE 10127, 101270J (2017) and references therein.

### SUMMARY OF THE INVENTION

The present invention provides improvements over current light field generators, such as holographic display systems, using AOMs such as SAW modulators. It can be used to limit the peak power required from the optical source, such as a laser. It also concerns multiple approaches for wave propagation cancellation among the light signals and SAWS within SAW modulators.

In general, according to one aspect, the invention features a light field projection system. This system comprises an array of surface acoustic wave (SAW) modulators for projecting a light field, an optical source generating light, and a directional switch for dividing the light among the SAW modulators of the array.

In embodiments, the directional switch divides the light for two or four or more groups of SAW modulators.

This division can be serial in time. Additionally, the different groups being associated with distinct quadrants of the array of SAW modulators or interlaced groups of SAW modulators.

The directional switch could be implemented as one or more Mach-Zehnder interferometers.

In general, according to another aspect, the invention features a light field generation method comprising generating light, dividing the light, and delivering the light to an array of surface acoustic wave (SAW) modulators for projecting a light field.

In general, according to another aspect, the invention features a light field projection system. This system comprises an array of surface acoustic wave (SAW) modulators for projecting a light field and a light modulator for generating light signals for the SAW modulators that encode brightness information for different views.

Preferably, a radio frequency (RI) drive circuit that generates the same RF signal for multiple SAW modulators. These RF signals can that determine the views. The light signals can be pulsed signals or continuous wave signals and encode brightness information.

In general, according to another aspect, the invention features a light field generation method. This method comprises generating light signals for an array of SAW modulators that encode brightness information and generating RF signals for the array of SAW modulators that encode views.

In general, according to another aspect, the invention features a light field generation system comprising one or more acousto-optic modulators, such as SAW modulators, in which scene-specific information is conveyed in optical signals provided by light modulators to the acousto-optic modulators.

In general, according to another aspect, the invention features an acousto-optic modulator for a light field generation having a continuous waveguide for light re-circulation.

In general, according to another aspect, the invention features a SAW modulator, including a SAW substrate and one or more light emitting chips bonded to the SAW substrate.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1A shows a proximal face of an exemplary projector module including two edge-fire light field generator devices to which the invention could be applied;

FIG. 1B is a side view of the exemplary projector module showing one of the light field generator devices, further showing the light propagating through one if its edge-fire SAW modulators and exiting from the device;

FIG. 1C is a partial front view of the exemplary projector module 400 showing the routing of RF feeds to the SAW transducers of a light field generator device;

FIG. 2A and 2B are a perspective view and an exploded perspective view, respectively, of a related projector module;

FIG. 3 is a perspective view of a holographic display or light field projection system with a stack of projector modules to which the invention is applicable;

FIG. 4 is a schematic side cross-sectional view of a face-fire SAW modulator in the light field generator device using a surface grating output coupler;

FIG. 5 is a schematic top view of a holographic display or light field projection system where the display is formed from a dual-column stack of face-fire light field generator devices;

FIG. 6 shows exemplary time-varying radio frequency (RF) signals and time-varying modulated light signals applied to a SAW modulator of a holographic display system, in accordance with an existing “traditional strobe” modality for wave propagation cancellation, where the RE signals are provided in a continuous fashion for inducing the SAWs and where the light signals are provided in a strobed fashion;

FIG. 7 is a timing diagram that illustrates how a controller module can generally accomplish wave propagation cancellation relative to an eye-integration time of individuals, for the “traditional strobe” modality;

FIG. 8 is a diagram that provides another illustration for how a controller module might perform wave propagation cancellation for the traditional strobe modality;

FIG. 9 is a block diagram showing a holographic display system of the present invention that can improve upon the traditional strobe modality;

FIG. 10 shows exemplary radio frequency (RF) drive signals and modulated light signals applied to a SAW modulator of the holographic display or light field projection systems such as shown in FIGS. 1-5, in accordance with a “traveling pulse” modality of the present invention for wave propagation cancellation, where the RF signal is provided in a discrete wave packets for creating the SAWs, and where the modulated light signals can be provided in either a continuous or a discrete/pulsed fashion;

FIG. 11A and FIG. 11B compare time varying RF drive signals used for exciting the SAWs within SAW modulators in the traditional strobe (FIG. 11A) and traveling pulse wave packet modalities (FIG. 11B);

FIG. 12A and FIG. 12B also compare the traditional strobe and wave packet modalities, respectively, by showing how the traditional strobe modality in FIG. 12A and the wave packet modality in FIG. 12B provide wave propagation cancellation between the SAW signals and the light signals co-propagating within the waveguide of the SAW modulator;

FIG. 13 shows an exemplary tabular depiction of brightness information for pixels of views as a function of location and view, where a location refers to a spatial position within the waveguide of the SAW modulator;

FIG. 14 shows one embodiment of a light modulator that can be used in the holographic display or light field projection systems such as shown in FIGS. 1-5;

FIGS. 15A and 15B shows another embodiment of a light modulator that can be used in the holographic display or light field projection systems such as shown in FIGS. 1-5, where FIG. 15B shows more detail for FIG. 15A;

FIG. 16A and 16B show different embodiments of a “race track” implementation of the holographic display or light field projection systems such as shown in FIGS. 1-5 for improving power efficiency; and

FIG. 17 shows a proximal face of an exemplary projector module including two edge-fire light field generator devices integrating one or more light emitting chips on the SA V substrates.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

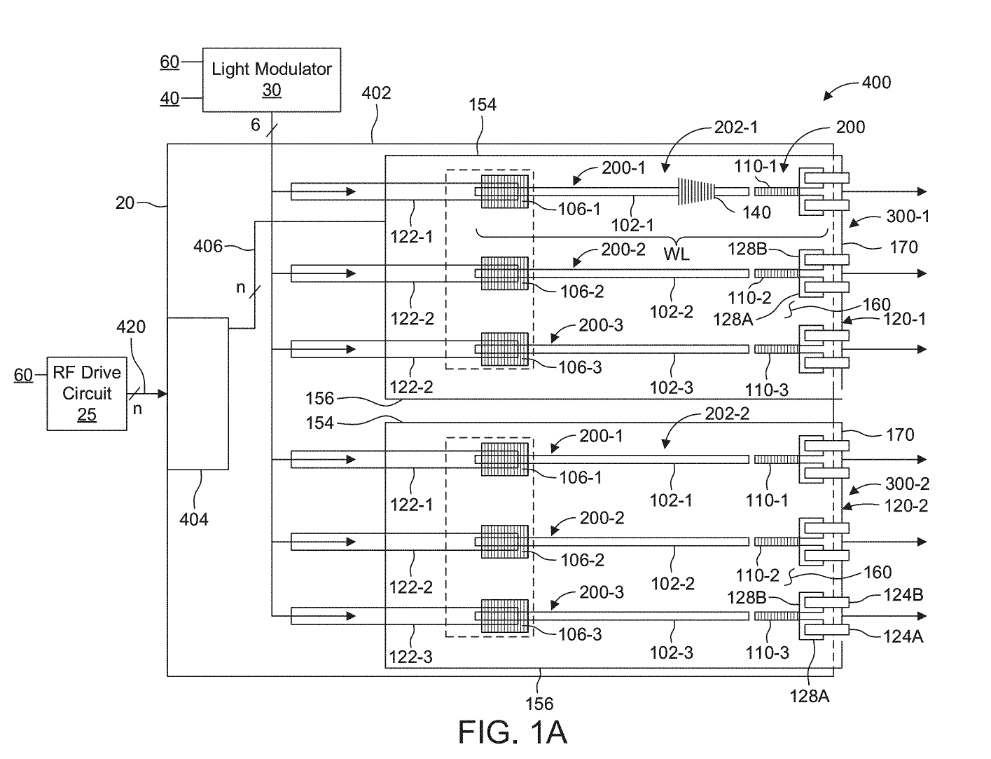

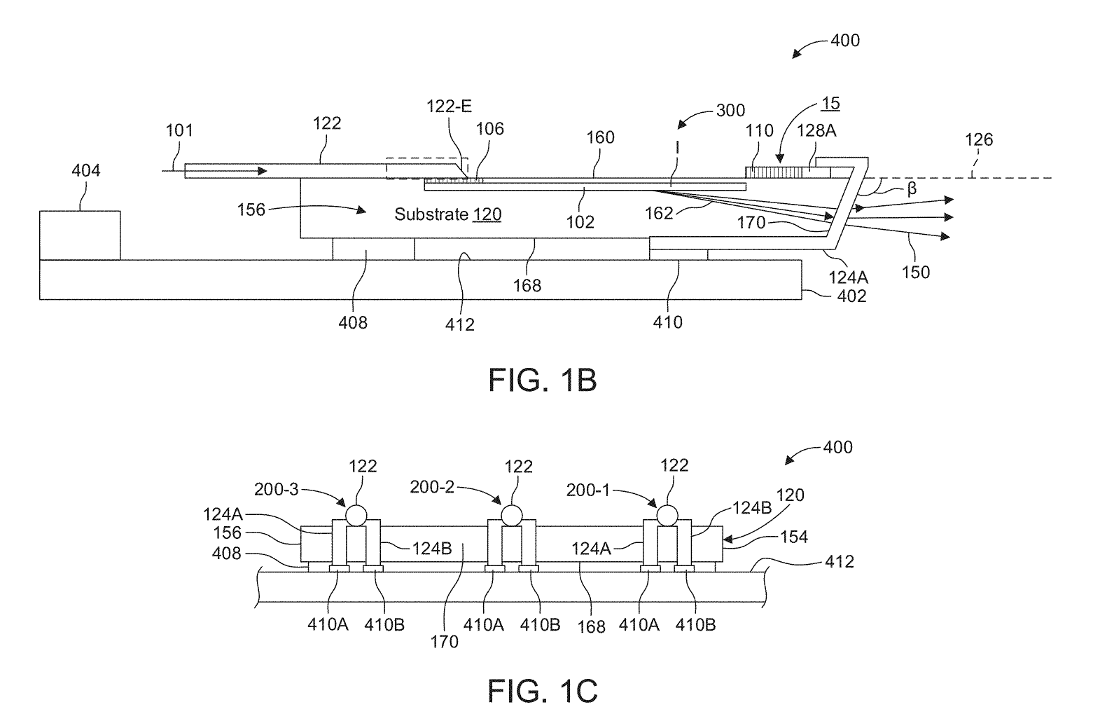

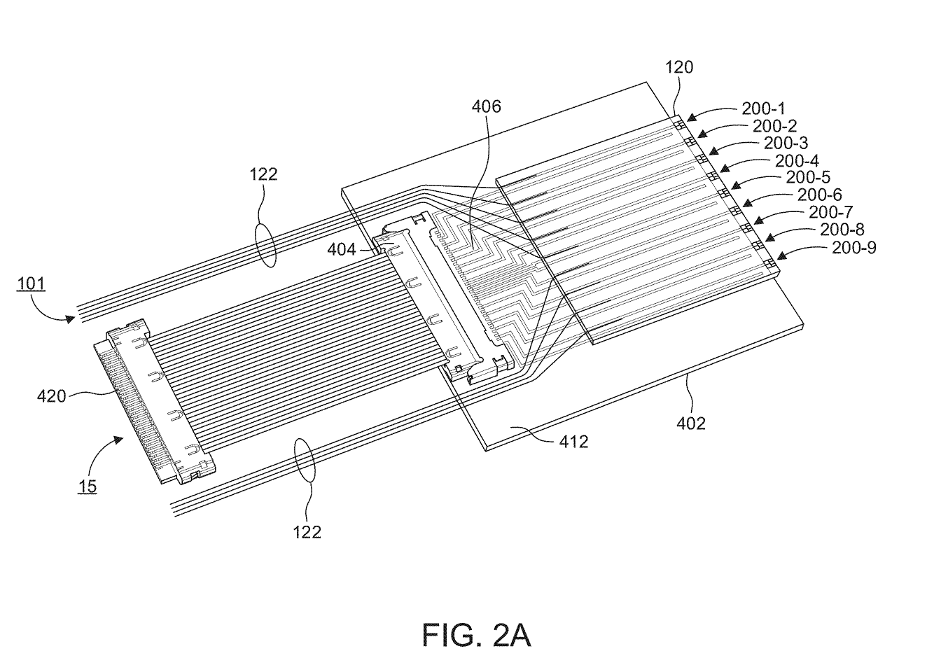

FIG. 1A shows a top view of a projector module 400. This module 400 is shown as one example holographic projector to which the principles of the present invention could be applied.

The projector module 400 includes two electro-holographic light field generator devices 300-1 and 300-2. They are located in the projector module 400 side by side with their proximal faces 160 extending parallel to the plane of the figure.

The two electro-holographic light field generator devices 300-1, 300-2 are mounted to a common module board 402. of the projector module 400. An RE connector 404 is installed on the module board 402 and interfaces with a ribbon umbilical cable 420, for example that provides one or more RE drive signals produced by an RF drive circuit 25 for this module 400 and other modules modules of a display system. At the common module board 402, the module RF connector 404 then distributes the RF drive signals via an RE feed line network 406.

Each electro-holographic light field generator device 300-1, 300-2 comprises an array 202 of SAW devices or modulators 200. The SAW devices 200 are fabricated in piezoelectric, crystalline, SAW substrates 120-1 and 120-2, respectively. The longitudinal axes of each of these SAW devices 200 extend parallel to each other, across each light field generator device 300. In the specific illustrated embodiment, each light field generator device 300-1, 300-2 includes an array 202 of three (3) SAW devices 200-1, 200-2, 200-3.

Of course, in other embodiments, usually larger numbers of SAW devices 200 are provided in each light field generator device 300 and/or in each SAW substrate 120. In a preferred embodiment, there are at least ten (10) such SAW devices 200 per each light field generator device 300/SAW substrate 120. Even higher levels of integration are envisioned.

Each SAW substrate 120 may be made, for example, of lithium niobate. In the current embodiment, the SAW substrates 120 are x-cut, y-propagating, measuring 5 millimeters (mm) (in the direction of the waveguides 102)×10 mm (in a direction perpendicular to the waveguides 102, but in the plane of the figure)×1 mm (substrate 120 thickness). Many other materials and design choices are available, however, including other piezoelectric materials and crystallographic orientations, and waveguide architectures such as planar, ridge, rib, embedded, immersed, and bulged. Doping such as MgO-doped lithium niobate may be useful, in some cases.

Each SAW modulator 200 includes an in-coupling device 106 (e.g., in-coupling grating or prism), a waveguide 102 and a SAW transducer 110 (e.g., an interdigital transducer or IDT, for example).

In the illustrated embodiment, the in-coupling device 106 of each SAW modulator 200 is an in-coupling grating. The grating receives input light 101 carried by a respective optical fiber pigtail 122 that terminates above the respective grating 106. This input light is provided from a light modulator 30 that supplies this light to this module 400 and the other modules in the system.

There are, of course, other ways to couple light into the waveguides 102 of the substrates 120, however. These include butt-coupling to the pigtails 122, free-space illumination, and fiber or free-space coupling into an in-coupling prism.

In a typical design, the waveguides 102 provide confinement of the input light in a TE (transverse electric, E-field in the plane of the device) guided mode. In a current embodiment, the waveguide 102 is 100 micrometers wide (in the plane of the figure) and 1 micrometer thick (perpendicular to the plane of the figure).

The SAW transducers 110 are driven by an RF input signal that creates a corresponding surface acoustic wave (SAW) 140. The surface acoustic wave 140 counter-propagates collinearly with the light in the waveguide 102. The SAW interacts with the guided mode light in the waveguides 102 to convert or diffract part of the light to a transverse magnetic (TM) polarization, leaky mode.

Here, the SAW transducers are interdigital transducers that are approximately 1 mm long (i.e., in the direction of the waveguide 102) and have features on the order of 1-3 micrometers. IDT pads 128A, 128B are each roughly 300 micrometers×300 micrometers.

Birefringence of the waveguide 102 and the SAW substrate 120 causes the TM leaky mode portion to leak out of the waveguide 102 into the SAW substrate 120 when guided mode light interacts with the SAW. The leaky mode portion of the light enters the substrate 120 as diffracted light 162, which travels within the substrate 120 towards an exit face. Here, the exit face is an end face 170 of each SAW substrate 120 of each light field generator device 300-1, 300-2.

In different embodiments, the IDTs 110 can occupy a variety of specific locations and specific orientations with respect to the waveguides 102. For example, in the illustrated embodiment, the transducers 110 are located near the end face 170 so that the surface acoustic waves 140 will propagate in a direction opposite the propagation of the light in the waveguides 102. In other embodiments, however, the transducers 110 are located near the in-coupling devices 106 so that the surface acoustic waves 140 will co-propagate in the direction of the light in the waveguides 102.

Also, there could be multiple SAW transducers 110 for each in-coupling device 106/waveguide 102. In such an implementation, each SAW transducer 110 might be responsible for a different specific bandwidth around a given center frequency (e.g.: 100-200 MHz, 200-300 MHz, and 300-400 MHz).

Moreover, additional transducers could be added to provide more than one beam-fan axis, such as by adding a transducer oriented at an angle to SAW transducers 110, for scanning along different axes.

in a specific embodiment, the array 202 of SAW optical modulators 200 may be packed relatively tightly with a waveguide separation 206 of between 10 μm-400 μm, for example, 50 μm. The waveguide length WL may be less than a centimeter to several centimeters (e.g., 1 cm) long.

FIG. 1B shows a side view of the exemplary projector module 400. It is also illustrative of the operation of an exemplary edge-fire SAW modulator 200 of the light field generator device 300. It shows one of the side facets (156) of the SAW substrate 120.

In terms of the SAW modulator operation, the input light signal 101 is carried to the device via the optical fiber pigtail 122. In the illustrated embodiment, end 122-E of the optical fiber pigtail 122 is polished at an angle and preferably metallized or coated with another reflective coating. Thus, the optical signal 101 transmitted by the pigtail 122 is reflected at the end 122-E toward the in-coupling grating 106 of the SAW modulator device 200. As a result, the optical signal is coupled into the waveguide 102 via the grating 106.

In some examples, the optical fiber pigtails 122 are arranged on and bonded to the surface of the substrate 120. In other cases, the pigtails are placed such that they lie on or within trenches formed into the proximal face 160 of the SAW substrate 120. Still another option involves a focused fiber beam at the modulator's entry face that has been polished at an angle.

At the other end of the SAW modulator device 200, the IDT 110 generates the surface acoustic wave (SAW) 140 that counter propagates with the light in the waveguide 102. When they interact along the length of the waveguide, as illustrated at point I, the surface acoustic wave 140 diffracts the optical signal 101 to create the diffracted light 162 that leaks out of the waveguide 102.

In the illustrated embodiment, the diffracted light 162 exits the substrate 120 via end face 170 as the exit face, i.e., edge-fire.

It should be noted, however, that in other embodiments, the exit face might alternatively be the distal face 168 or the proximal face 160, to create a face-fire configuration. One technique for creating a face-fire configuration is to mirror-coat the end face 170 and pick a different edge cut angle β (beta) for the end face 170. Another technique is to extend the length of the modulator so that the diffracted light has an opportunity to reach the distal face and possibly 1) add a reflective element, e.g. a reflective diffraction grating, to the distal side so that it redirects the light out towards the proximal face or 2) add a transmissive element, e.g. a transmissive diffraction grating, to the distal side so that it directs the light out the distal face.

In the specific illustrative example, the edge cut angle β is polished into the end face 170. The edge cut angle β is measured from a plane 126 of the proximal face 160, to the end face 170. Here, the edge cut angle β is preferably about 100 to 140°, or about 120°. As a. result, when the diffracted light 162. exits the substrate 120 into air, for example, the edge cut angle β in combination with the refraction at this interface causes the exit light 150 to propagate in a direction that is generally parallel to the longitudinal axes of the SAW devices 200 and parallel to the plane 126 of the proximal faces 160 of those devices 200. Preferably, the exit light is controlled to have wavefront curvature, such as pixels with corresponding focus.

Exit optics are typically further used. Their purpose includes angle magnification, polarization, and elliptical diffusing. The optics can be separate from the substrate 120 or fabricated on the end face 170, in examples.

In terms of the construction of this specific example projector module 400, the SAW substrate 120 is attached to a top face 412 of the module board 402. In the illustrated implementation, the rear end of the substrate 120 can be separated from the top face 412 of the module board 402 via an optional rear standoff block 408. On the other hand, the front end of the substrate 120 is separated from the top face 412 of the module board 402 via a series of front conductive blocks or pads 410.

In addition to supporting the front end of the substrate 120, the front conductive blocks 410A, 410B are also utilized in the delivery of the RF signals to the IDTs 110 of the SAW devices 200. In more detail, the RF signals from the RF connector 404 are routed over the top face 412 or through layers of the module board 402 in the RF feed line network 406 of the module board 402 and to the front standoff blocks 410, which are electrically conducting. Pairs of conformal RF traces 124A and 124B electrically connect to respective front standoff blocks 410A, 410B. The conformal RF traces 124A and 124E then extend forward, on the distal face 168 of substrate 120 and then wrap around the edge to the end face 170, and extend over the end face 170 to the proximal face 160. On the proximal face, the conformal RF traces 124A, 124B run rearward to make contact with respective IDT bond pads 128A, 128B that connect with the IDT 110.

FIG. 1C shows a front view of the projector module 400. It best illustrates how each SAW device 200-1, 200-2, 200-3 of the SAW substrate 120 has a pair of conformal RF traces 124A, 124B that wrap-around the end face 170 to carry the RF signal for each IDT 110 from the respective front conductive blocks 410A, 410B on the bottom of the substrate 120 to the DT 110 on the top of the substrate 120.

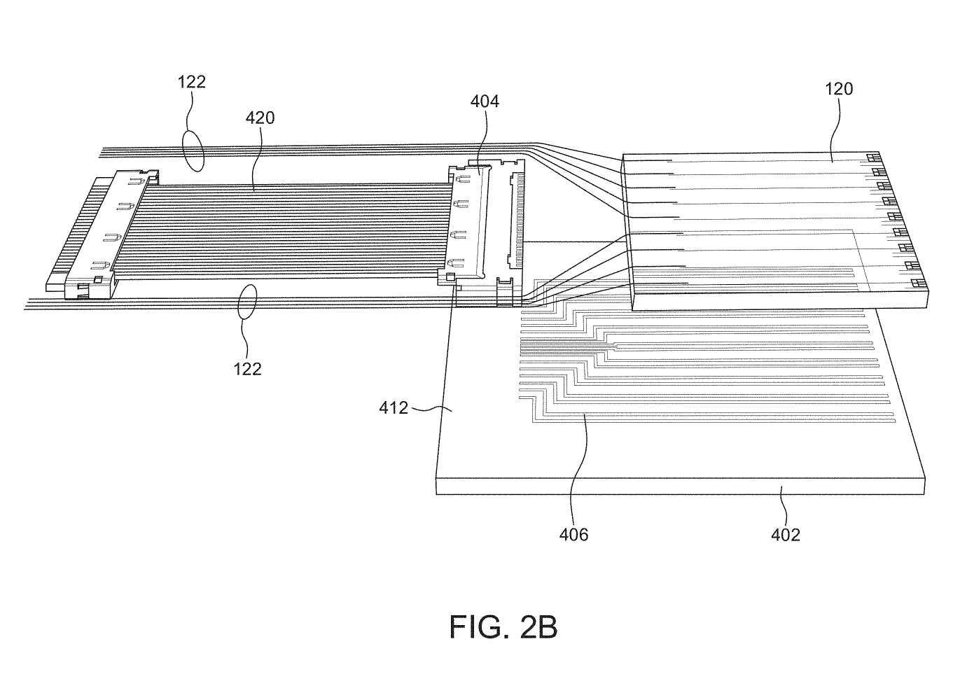

FIGS. 2A and 2B show a related example of the previously described projector module 400. It is generally similar to the projector module described with respect to FIGS. 1A-1C, but differs in a few ways.

Here, a single SAW substrate 120 is attached to the top of the module board 402, rather than two as depicted in FIG. 1. The substrate, however, is more highly integrated. It includes nine (9) SAW modulator devices 200-1 to 200-9.

More details are shown concerning the RF feed line network 406. The feedlines include an array of traces that run on or through the board 402 and carry separate RF signals. In this way, the module board 402 has an array of RF teed lines 406 for providing RF signals to the substrates.

Also shown is a specific implementation of the module RF connector 404. A ribbon umbilical cable 420 plugs into a ribbon-style connector 404 as the module RF connector. The connector 404 is attached to the top face 412 of the module board 402.

The optical fibers 122 run in groups and connect to provide the optical signals to the separate SAW devices 200.

In other embodiments, however, the ribbon-style connector 404 is replaced with Pogo pins, press-fit, conductive adhesives, wire-bonding, or ZEBRA-brand (Fuji Polymer Industries) elastomeric connectors.

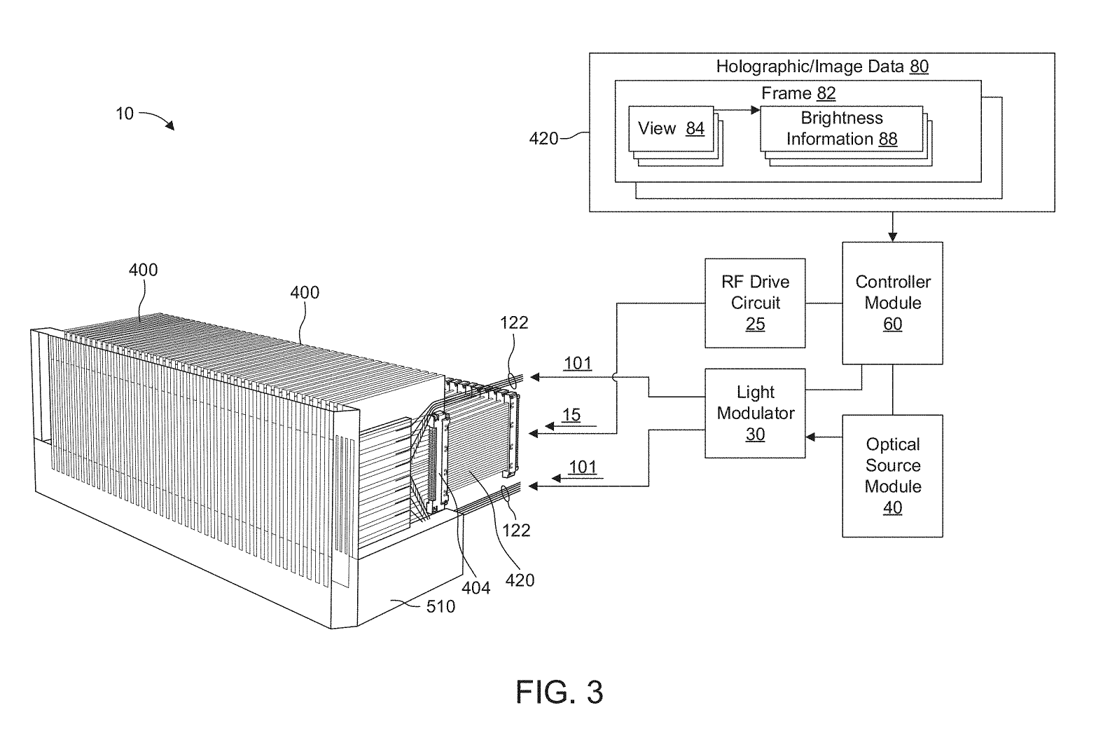

FIG. 3 shows a holographic display or more generally a light field generator system 10 including a stack of projector modules 400. The modules are held vertically by a common system mounting block 510. Specifically, 44 slots are provided in the mounting block 510 in the illustrated embodiment. Each of these slots receives a separate projector module 400.

In this way, a two-dimensional array of SAW modulators is implemented that can be controlled to project a light field that will enable one or more views of different pixels depending on the location of the viewer relative to the system 10. The projected light field will mimic some or all of the depth cues of a real 3D object.

The holographic display system 10 also includes a controller module 60, and the RF drive circuit 25, the light modulator 30, and the optical source module 40.

In one example, the RF drive circuit 25 can generate hundreds of RF signals 15 that are distributed to the projector modules 400 of the system 10.

The optical source module 40 will often include one or more lasers. These lasers will each generate light signals of different wavelengths (colors). In one example, the optical source module 40 includes three separate lasers that each generate light signals 101 of different visible wavelengths, such as red, green, and blue light. Each wavelength of light signals 101 is preferably provided as the input to each separate SAW modulator 200, according to one implementation.

In operation, the controller module 60 receives frames 82 of holographic image data 80. These frames 82 might represent “still” images of a scene. The frames 82 will further encode one or more views 84 and brightness information 88 for each view 84.

The desired light field within each frame 82 (e.g. views 84 and brightness information 88 for each view 84) can be represented many ways. Typically, the views 84 are 2-D representations of pixels such as in a bitmap, though other implementations are possible. The pixels within each view 84 are encoded at the same angle of illuminated light.

In conjunction with the SAW signals, the controller module 60 also controls the optical source 40 and/or light modulator(s) 30 to create light signals 101 with appropriate time, intensity and duration to create the desired output light field. For this purpose, in one example, the controller module 60 can control the generation of the light signals from the source 40 to have the appropriate time, intensity and duration by strobing/electronically pulsing the optical source 40.

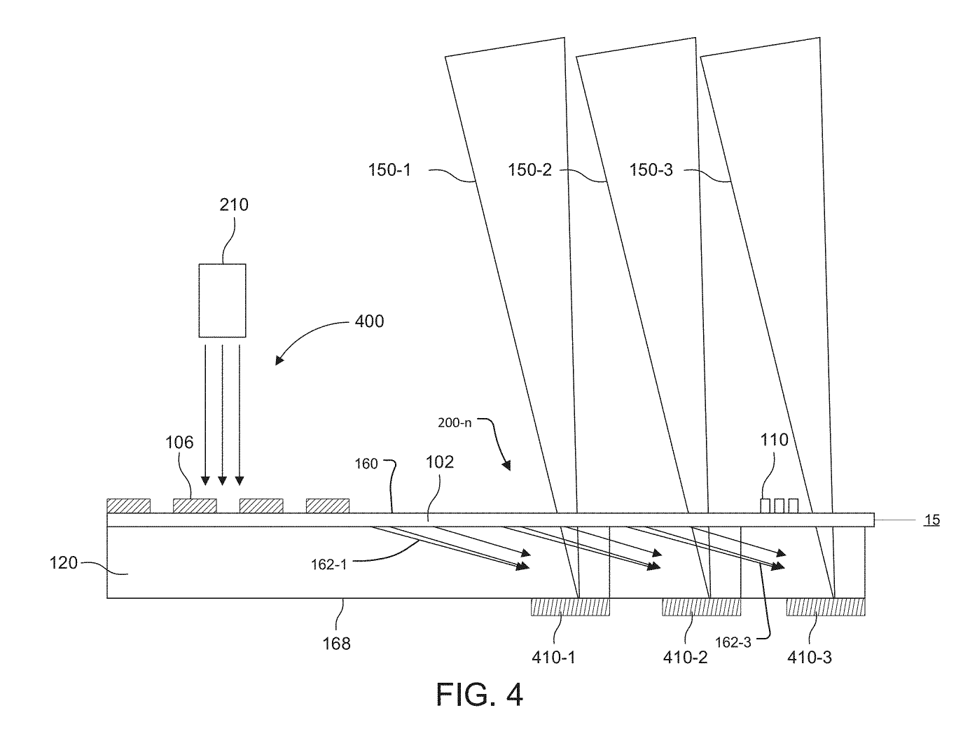

FIG. 4 shows a side cross-sectional view of projector modules 400 showing an exemplary SAW modulator 200-n having a face-fire configuration. which uses multiple surface gratings output couplers 410-1- 410-2, 420-3 fabricated on the distal face 168 of the optical substrate 120.

The surface gratings output couplers 410 can be fabricated via standard photolithography or laser writing processes.

Here, the diffracted light travels through the substrate and is reflected by gratings 410 to exit the proximal face 160 at potentially three or more emissive regions or pixels corresponding to exit light beams 150-1 to 150-3. In other examples, the gratings 410 could be transmissive optics or gratings such that light exits via the distal face 168.

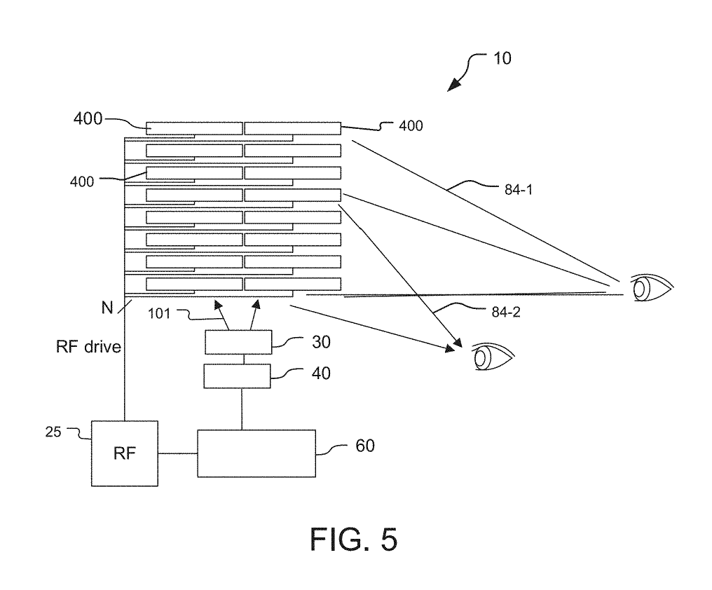

FIG. 5 shows another a holographic display or light field generator system 10. The RF controller 405 and a processor 909 are also shown. Here, the electro-holographic light field generator devices 300 are arranged in a dual column stack with each module 400 including 10's to 100's or more modulators 200. Further, each modulator 200 could have three (shown) or more, such as five or ten or more, emissive regions/output couplers 410,

Each of the projector modules 400 receives input light 101 generated by illumination source 40 and modulated by modulator 30. From this light, it produced different views 84 in different directions.

It is also important to note that display or light field generator systems 10, though described in the specific context of 3D display systems, also can usefully be applied to other applications such as optogenetics, 3D printing, cloaking, and near-eye displays for augmented reality/virtual reality (AR/VR).

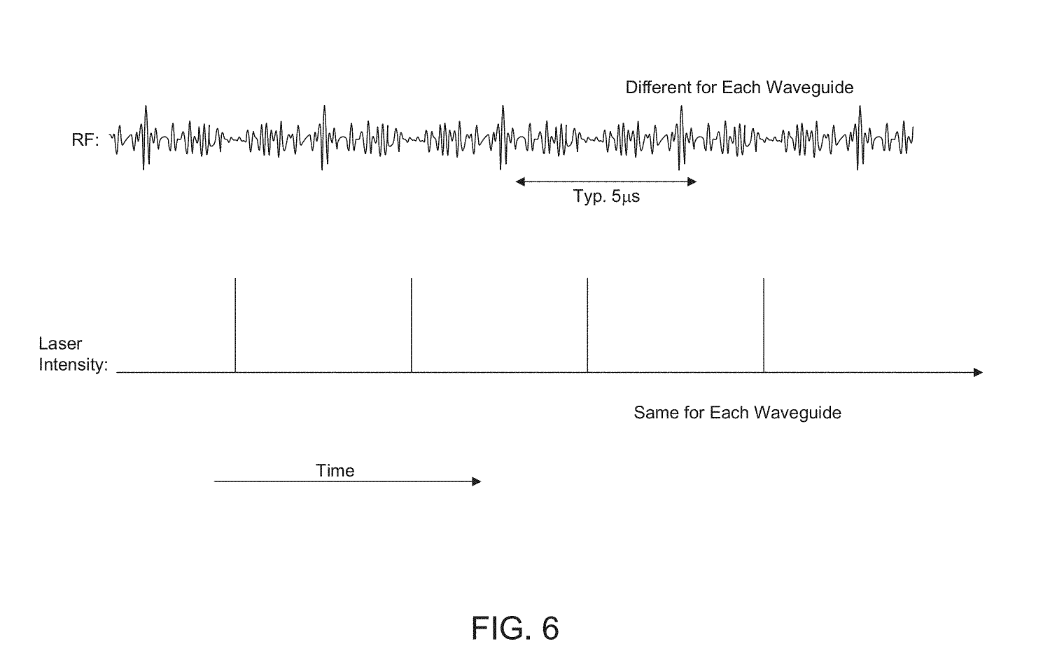

FIG. 6 shows an exemplary radio frequency (RF) signal and an exemplary light signal of an existing “traditional strobe” modality.

When these signals are applied to SAW modulators, the arrangement will provide for wave propagation cancellation. Since the light signal is simply pulsed and distributed in common the SAW modulators, holographic display systems of this type do not necessarily require the light modulator.

In the “traditional strobe” modality, the controller module directs the RF drive circuit to provide modulated RF signals, and directs the optical source to “strobe” the light signals that are synchronized with the modulated RF signals. When illuminated by a strobe light, the SAW signals induced in the SAW modulators by RF drive signals can be made to appear stationary, or can be changed in a controllable way, rather than appear to travel along the waveguide.

In the “traditional strobe” modality, the waveform of the RF signals is typically different for each SAW modulator, and different for each frame. In contrast, the intensity-vs-time profile of the light signal is typically the same for each SAW modulator in the system, and the same for each frame.

As a consequence of the traditional strobe modality scheme, the RF signals and thus the SAW signals encode image and view information, particularly how much brightness information is included into which views. The brightness information of each view (e.g. the brightness of each pixel within a 2-D map of pixels forming a view, in one example) is controlled by the SAW waveform. If the SAWs have a strong Fourier component at a certain frequency, the SAW modulator sends a significant amount of light in the corresponding direction. The light signals provide brightness in the trivial sense that light is bright, but do not encode the brightness information. The light signals in the traditional strobe modality are generally the same regardless of the view of the scene, i.e. the light signals encode no information whatsoever.

The traditional strobe modality has disadvantages. Each SAW modulator requires a different RF waveform/RF signal. This poses challenges for the hardware and software which calculate the waveforms, the RF chain for generating, frequency-converting, and amplifying the RF signals, the controller module, and the RF cabling/waveguide(s), and ultimately to the fingers of the IDTs of the SAW modulators. Finally, the RF drive circuit approaches a 100% duty cycle for generating RF signals for images of bright scenes and the RF signal amplitude must also be carefully controlled to control pixel brightness.

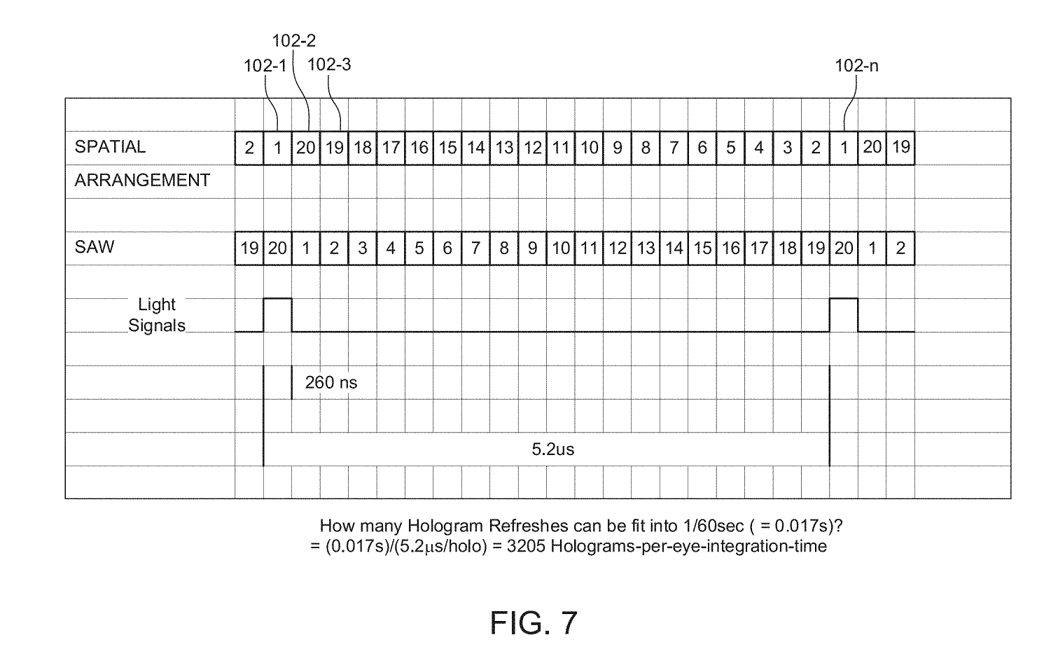

FIG. 7 is a timing diagram that illustrates how the controller module of a holographic display system might generally provide wave propagation cancellation for the traditional strobe modality.

With reference to a waveguide 102 having pixels, or spatial columns 102-1, 102-2, 102-n at different locations along the length of the waveguide 102, the controller module can provide wave propagation cancellation between the SAW 140 and the light signals propagating within and along the waveguide 102, relative to an eye-integration time of individuals. In this modality, because the SAW 140 that carry the views 84 and brightness information 88 for each view 84 complete their propagation along the entirety of the waveguide 102 according to a sound propagation time of each SAW 140, the controller module 60 typically signals the light source 40 to provide its light signals 101 to the waveguide 102 only once per sound propagation time of the SAW 140.

The SAW is represented as a collection of smaller SAW subsignals, which are individual labeled “1,” “2,” “3,” . . . “20”, each of which are positioned at a different spatial column 102 along the length of the waveguide at a given snapshot in time.

For illustration purposes, in this example, the waveguide 102 is 20 millimeters (mm) long, while the desired spatial resolution of the holographic image formed by the modulated emitted light signals is only 1 mm. Therefore, there are twenty (20) pixels 102-p along the waveguide 102, each of which has a desired profile of brightness for each view 84, and a corresponding SAW sub-signal which can generate this brightness-vs-view profile. These SAW sub-signals are labeled “1” through “20”. An operator of the holographic display system typically has flexibility in the assignment of a SAW sub-signal to its instantaneous or time-averaged diffractive purpose; typical examples from the literature include a pixel, a hogel and a wafel.

It is important to note that FIG. 7 is a simplified description for purposes of illustrating how the holographic display systems generally provide wave propagation cancellation for the traditional strobe modality. In practice, the spatial columns or pixels 102-p are typically not separate/independent, and subsequently neither are the SAW sub-signals 89. Rather, there may be overlapping coherent chirps, necessitating SAW frequency dispersion compensation, etc. Also, the pulse length may be shorter than the desired spatial resolution in some situations.

The controller module directs the optical source to generate pulsed light signals, where the pulses are timed to the SAW propagation time through the waveguide, which is generally much less than the eye-integration times of users. Eye-integration times of users is typically 1/60 of a second (0.17 sec), which corresponds to an eye “refresh rate” of 60 Hz. The controller module can provide a number of hologram refreshes per eye-integration time based upon the waveguide length, SAW velocity, and perhaps temporal multiplexing configuration within each frame.

In the illustrated example, the controller module might utilize a 260 nanosecond (ns) periodic pulse to the light source, thereby producing a modulated light signal having a period of (20)×(260 ns)=5.2 microseconds. As a result, the controller module can provide 3205 holograms per eye integration time: (0.17 seconds per eye-refresh integration time)×(5.2 microseconds per hologram)=3205 holograms per eye integration time.

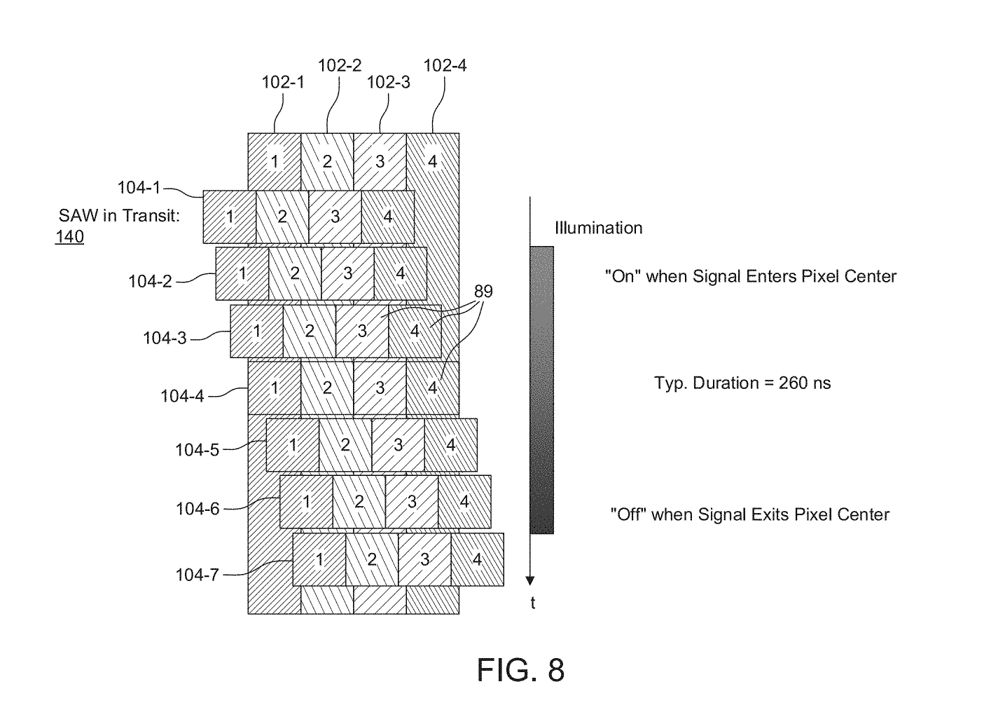

FIG. 8 provides another illustration for how the controller module generally provides wave propagation cancellation for the traditional strobe modality as in FIG. 4. Here, the time axis is down, going down the page, rather than across as in FIG. 7, while the horizontal axis represents the spatial extent of a section of a waveguide, subdivided for illustration purposes into four sub-sections 102-1 to 102-4, while the SAW is similarly divided into sub-signals 89. The SAW sub-signal is given the same label as the corresponding sub-section of the waveguide in which this sub-signal is intended to be displayed.

The modulated light signals are created according to the timing diagram of FIG. 7, where the pulse width of the modulated light signals is 260 ns.

In the illustrated example, a pixel is illuminated (e.g. “turned on”) when the SAW is positioned such that each of its sub-signals 89 is at least half overlapping its corresponding waveguide sub-section. When the same SAW 140 has traveled such that its sub-signals are less than half overlapping their corresponding waveguide sub-section at a later point in time, according to the pulse width (here, 260 nanoseconds), the illumination is removed from the waveguide.

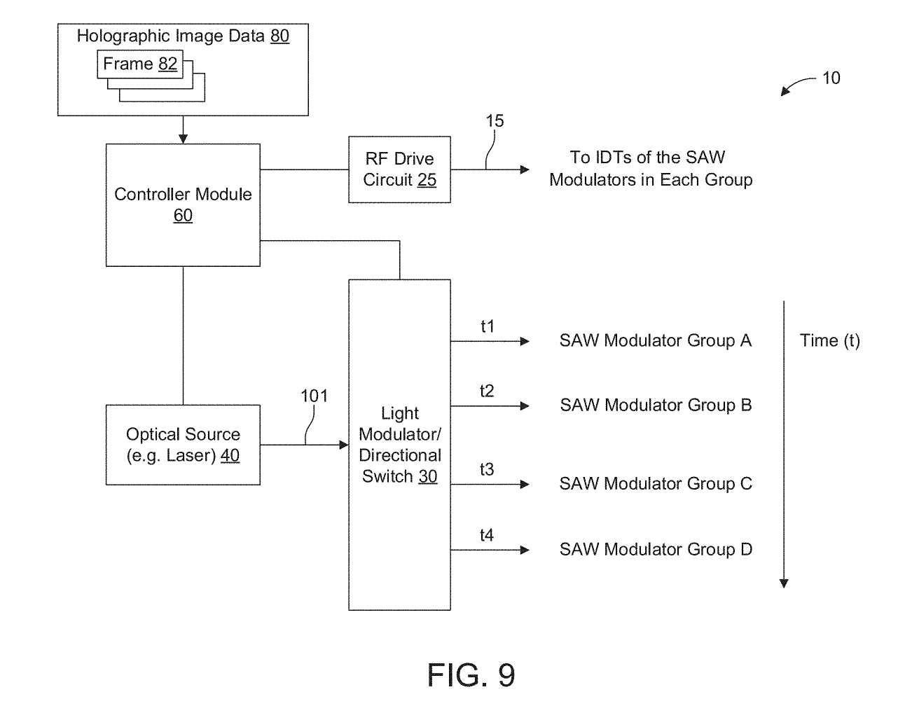

FIG. 9 shows the control module 60 and the optical signal distribution system for the holographic display or light field projection systems such as shown in FIGS. 1-5 that improves upon the existing traditional strobe modality described in connection with FIG. 6-8.

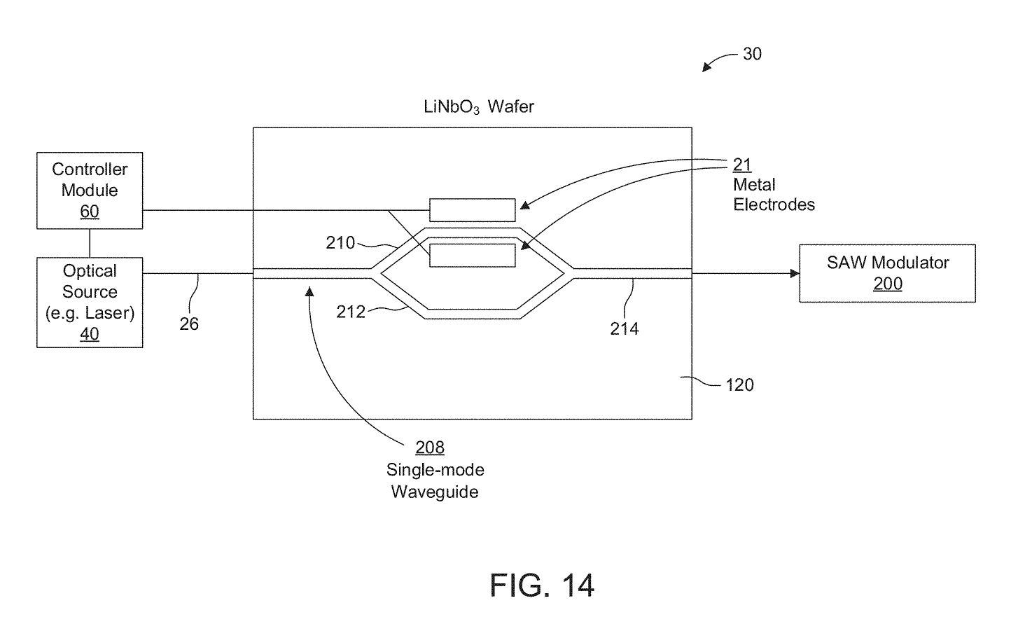

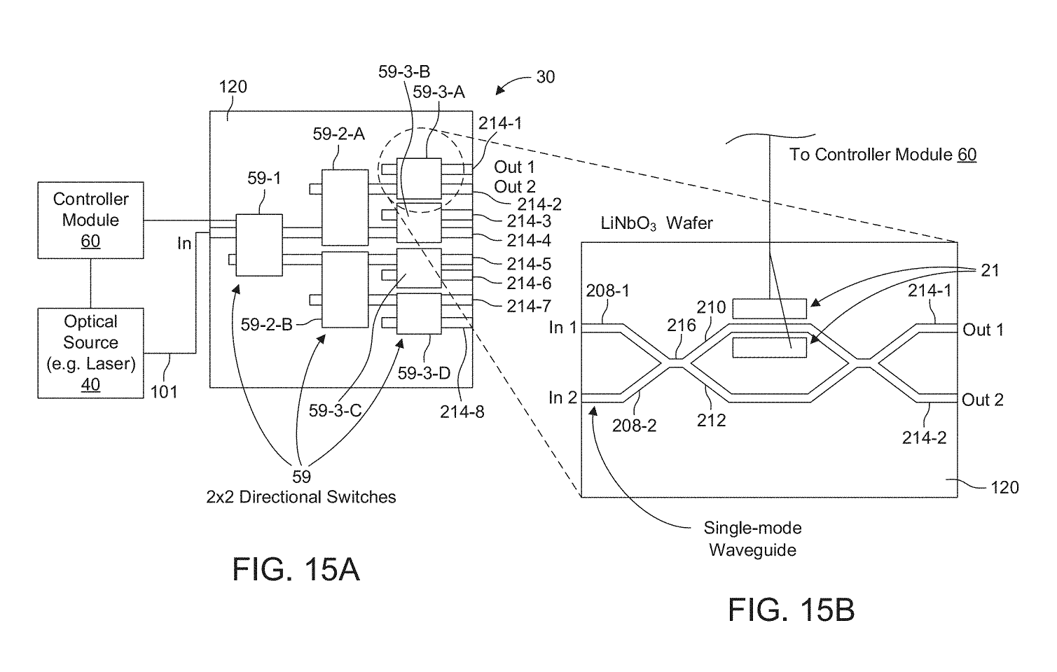

In more detail, the light modulator 30 is implemented as a directional switch that multiplexes the light signals 101 from the optical source module 40 among different groups of SAW modulators 200 of the light field generator system 10. The modulator/directional switch 30 might be a cascade of Mach-Zehnder interferometers as in FIG. 14 and FIGS. 15A/15B, described hereinbelow, Use of the modulator/directional switch 30 can correspondingly reduce the peak power output required by the optical source module 40.

In more detail, in one implementation, four exemplary groups of SAW modulators A through D are part of a holographic display system 10. In other implementations, there may be only two groups of SAW modulators. However, in other embodiments, there might be eight (8) or more groups.

The different groups associated with distinct quadrants of the two-dimensional array of SAW modulators of the system 10 in one example. In other embodiments, the different groups might be alternating projector modules 400 within the two-dimensional array of SAW modulators of the system 10, however.

Unlike the traditional strobe approach to synchronization, however, not all groups of the SAW modulators A-D are strobed at the same time. The controller module 60 instructs the modulator/directional switch 30 to alternate the strobing of the light signals 101 serially among the four different groups of SAW modulators A-D. The modulator/directional switch 30 directs the light signals sequentially to the first group during time slot t1, to the second group during time slot t2, to the third group during time slot t3, and the fourth group during time slot t4, then the process repeats. As a result, in this specific example, the peak power of the optical source 40 can effectively be reduced by a factor of 4.

The reduction in the peak power required by the optical source module 40 has several benefits. Various component requirements/specifications of the system 10 can be relaxed, which includes selection of the laser optical sources 40 and the current drivers that power the laser optical source module 40, choice of external waveguides, fiber optic cabling, and/or couplers that the various light signals 101 pass through before being split into the individual waveguides 102 of the SAW modulators 200.

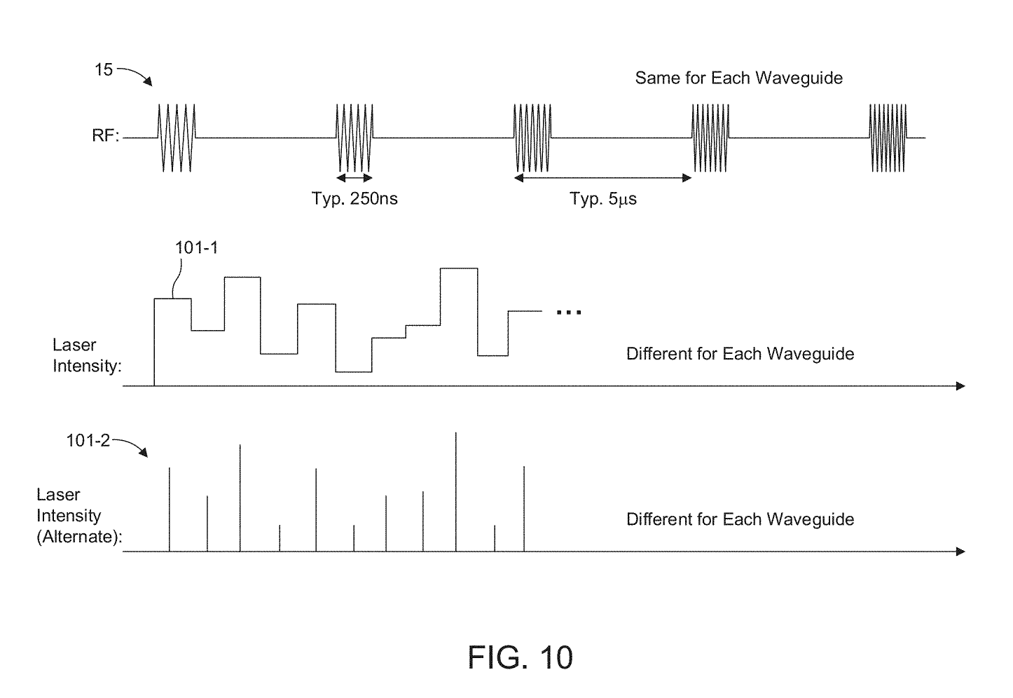

FIG. 10 shows another invention in which image and view information is encoded into the optical signals 101 delivered to each of the SAW modulators 200 of the light field generator or holographic display system 10 of FIGS. 1-5 by operation of the light modulator 30.

In more detail, exemplary RF signal 15 is shown and the same RF signal is distributed to multiple SAW modulators 200. In practice, the same RF signal might be distributed to different groups of SAW modulators in a sequential fashion or to perhaps all of the SAW modulators 200 of the system 10, in parallel.

On the other hand, different modulated light signals 101-1 and 101-2 are generated for each of the SAW modulators 200 of the system 10. These light signals 101 might be in the form of continuous wave (CW) signals 101-1 or pulsed signals 101-2 as shown.

In this approach, the SAW signals 140 generated in each SAW modulator 200 encode the views that are to be projected, and the light signals 101-1 or 101-2 encode/carry the brightness-vs-position information 88.

This approach might still be characterized as a variant of the traveling pulse modality. Different traveling pulses are generated by the RE drive circuit 25. These different traveling pulses of different RE frequencies are required for each view 84 because the traveling pulse frequency encodes the view 84.

In operation, each view 84 can he repeated multiple times because there is enough time in one 60 Hz frame to do so, and because repeating each view reduces the peak power requirements upon the optical source module 40 and other components. In certain time-multiplexing scenarios, however, it may be advantageous to provide only one traveling pulse per view 84 of each frame 82.

The modulated light signals 101 generated by the light modulator 30 are different for each SAW modulator 200 within the two-dimensional array of SAW modulators of the system 10, however.

Either continuous wave (CW) 101 or pulsed 101 modulated light signals can be used. In examples, the pulsed 101 modulated light signals could be applied if micro-lenses are utilized to spread the light, to avoid scattering at the boundary between pixels, and for locating the pulse at the appropriate part of the pixel to get the desired view direction. The continuous wave (CW) 101 modulated light signals are typically applied when the brightness carrying modulated light signals 101 propagating within the waveguide 102 of SAW modulator 200 require a change in brightness/intensity at an appropriate time in synchronization with the view-information-carrying SAW signals 140 that are also propagating within or near the waveguide 102.

One possible approach to time synchronization is to have a butler for each SAW modulator 200, update the buffers in a time-multiplexed way, but then read the buffer values for each SAW modulator 200 simultaneously, to match the simultaneous SAW signal waves 140. Another possibility is to have different SAW modulators 200 switch intensities at different times, but compensate for that by time-offsetting the SAW modulators 200, output optics, or other components between different SAW modulators 200.

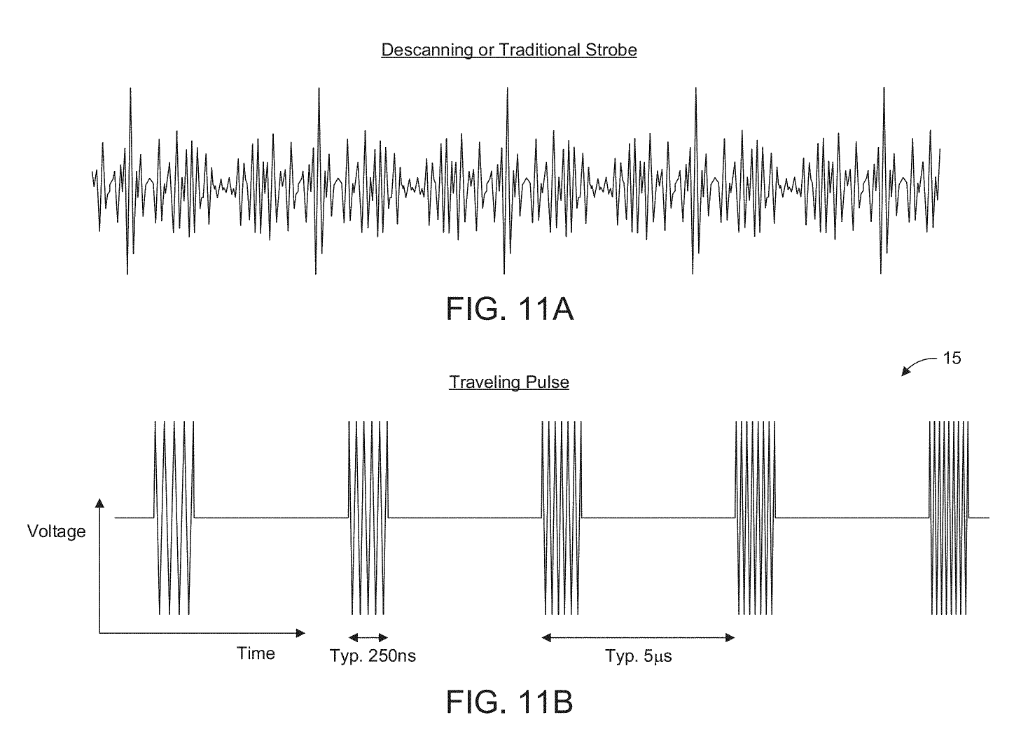

FIG. 11A shows an exemplary RE signal used in the traditional strobe modality to excite a SAW within the SAW modulator, where FIG. 11B shows an exemplary RF signal 15 used in the traveling pulse modality for the same purpose.

In FIG. 11A, the traditional strobe modality requires that the RF drive circuit 25 generate a separate modulated. RF signal 15-1 for each SAW modulator 200. The RF signals 15-1 have up to a 100% duty cycle (for bright scenes), Therefore, RF power consumption can be a significant issue. Moreover, it can be difficult to amplitude modulate the RF signals in order to encode the brightness for different views/pixels.

In the traveling pulse modality, in FIG. 11B, in contrast, the RF power consumption of the RF drive circuitry 25 can be significantly reduced, because if the peak power of both the (laser) optical source 40 and the RF drive circuitry 25 are held constant, then the average RF power consumption is lower thanks to the low RF duty cycle. In one embodiment, the duty cycle of the RF signal is less than 50%. Preferably it is about 25% or lower, as shown. Further, in the current example because brightness information is encoded in the light, RF signals are either on or off rather than amplitude modulated, which allows them to be generated and amplified in a more power-efficient way.

Additionally or alternatively, the optical source 40 peak power can be reduced, which prolongs the life of the laser source 40 and reduces damage to the components of the system 10 caused by the laser source 40.

For bright scenes, the light signals 101 diffract off the SAW signals 140 all along the length of waveguide 102 within the SAW modulators 200 of the array of the system 10. Therefore, if the outcoupling efficiency of the guided modes into the modulated emitted light signals 150 is high, then there is less light at the end of the waveguide 102 than at the beginning. Addressing this problem requires a combination of low outcoupling efficiency, use of short waveguides 102, software pre-compensation for this effect, and additional headroom in the display brightness budget, all of which are undesirable. In the traveling pulse modality, in contrast, light is only emitted from a small part of the waveguide at a time, even in a very bright scene, so this issue does not arise.

In FIG. 11B, for the traveling pulse modality, the system 10 can generate only one RF signal 15 and apply it to all SAW modulators 200 of the array or large groups of modulators 200. In some implementations, there is a tradeoff where in exchange for simpler RE circuitry and signaling, the traveling pulse modality can require more complicated (waveguide-specific and scene-specific) light modulator control. However, the light modulators 30 require comparably much simpler, lower-bandwidth, and lower-frequency drive signals than the waveforms of the SAW signals 140.

In the traveling pulse modality, typically, the pulses of the SAW signals 140 are relatively narrow-band (compared to the total bandwidth used in the display), with different-frequency pulses used for different views. The length of each pulse of the SAW signals 140 is comparable to the desired spatial resolution of the display, for example 250 ns (if the speed of sound is 4 km/s and the desired spatial resolution is 1 mm), and the bandwidth of the pulse is comparable to the reciprocal of that number, for example 4 MHz and is typically between 2 and 6 MHz.

As in the traditional strobe modality, the traveling pulse modality allows long waveguides 102 (longer than the pixels or unit of spatial resolution/view information) and has no moving parts. However, the most fundamental difference is that in the traveling pulse modality, the scene-specific brightness information 88 is conveyed via the light modulators 30 rather than via the RE drive circuit 25.

In a variation of the traveling pulse modality, the pulses of RP signals 22 applied to the SAW transducers 110 all have the same frequency, and the wavelength of the laser optical source 40 is changed instead.

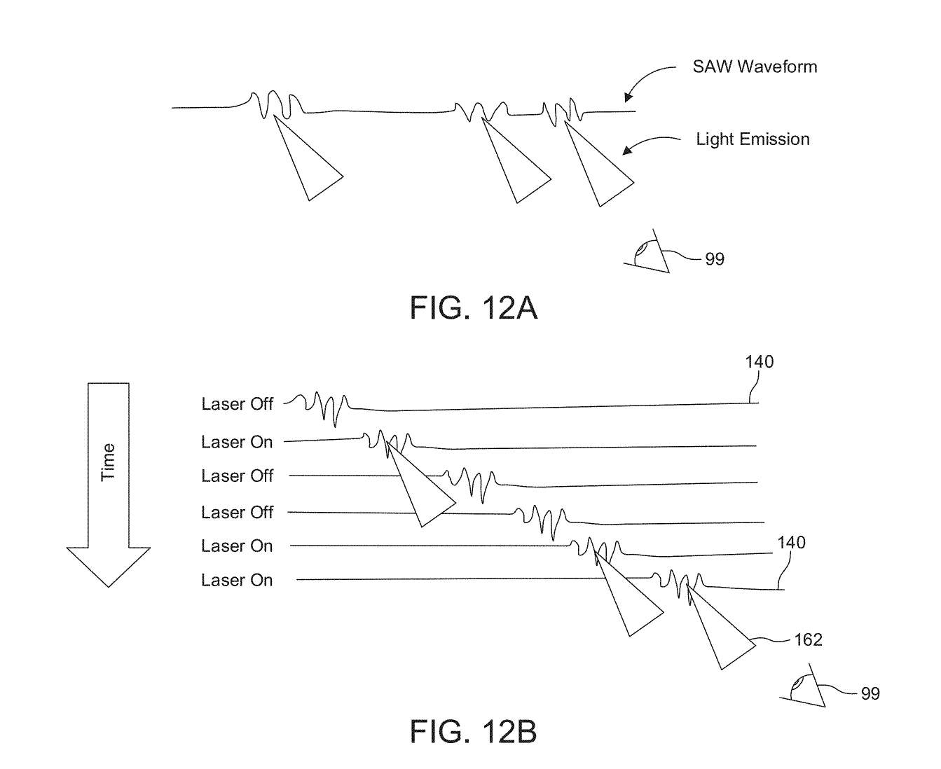

FIG. 12A and FIG. 12B provide additional comparison between the traditional strobe (FIG. 12A) and traveling pulse FIG. 12B) modalities.

In FIG. 12A, for the traditional strobe modality, a waveform of SAW signals 140 is excited within the waveguide 102 from an RF signal, such as RF signal having a continuous spectrum as shown in FIG. 12A. The SAW signals 140 encode the contents of each frame 82 (e.g. the entirety of the views 84 and the brightness information 88 of each view for each frame 82) at once. When the SAW signals 140 are completely “written” into the waveguide 102, a strobe light fires once. The process is then repeated, where a new waveform of the SAW signals 140 (often a fresh copy of the same waveform as before) enters and traverses the length of the waveguide 102 and is then strobed. The strobe rate is equal to or slower than the inverse waveguide acoustic transit time.

In FIG. 12B, for the traveling pulse modality, a pulse of RF signals 15 is applied to the IDT 110 of the SAW modulator 200, as opposed to a continuous RF signal applied to the IDT of the SAW modulator for the traditional strobe modality of FIG. 12A. In response to the pulse of RF signals 15-2, a corresponding SAW pulse 140 are excited within the substrate 120 and the waveguide 102 This pulse typically encodes one particular view 84 of a frame 82.

As the SAW pulse 140 propagates within and long the waveguide 102, the controller module 60 directs the light modulator 30 to make the light signals 101 of the optical source brighter and dimmer depending on the desired light in that view of the pulse's current location as shown in FIG. 12B.

To create a quasi-continuum of different brightness levels, one or more lasers of the optical source module 40 can be modulated in intensity, and/or switched on and off quickly (faster than the desired spatial resolution divided by the speed of sound) with modulated duty-cycle, and/or, if the same type of pulse is transmitted multiple times within the same visual frame 82. The laser intensity could also be set to more than one level during the various repetitions of each pixel-view, where the eye of the observer 99 averages the brightness level to an intermediate brightness level.

When the SAW pulse 140 has completed passing through the waveguide 102, a new pulse of the RF signal 15-2 excites a corresponding new pulse of the SAW signals 140 within the waveguide 102 that encodes the next view 84 of the frame 82. This process is repeated for the remaining views for the current frame 82 and for all subsequent frames. Thus in a system that can projected 8 different views, the frequency of the pulses are selected to access each of those views using 8 different frequencies.

As a variation, the pulse of the SAW signals could also encode a certain angle and certain focal plane, which has some benefits as explained in Smithwick et al., “Real-time shades rendering of holographic stereograms”, Proc. SPIE 7233, 723302 (2009), if this is compatible with other aspects of the optical design.

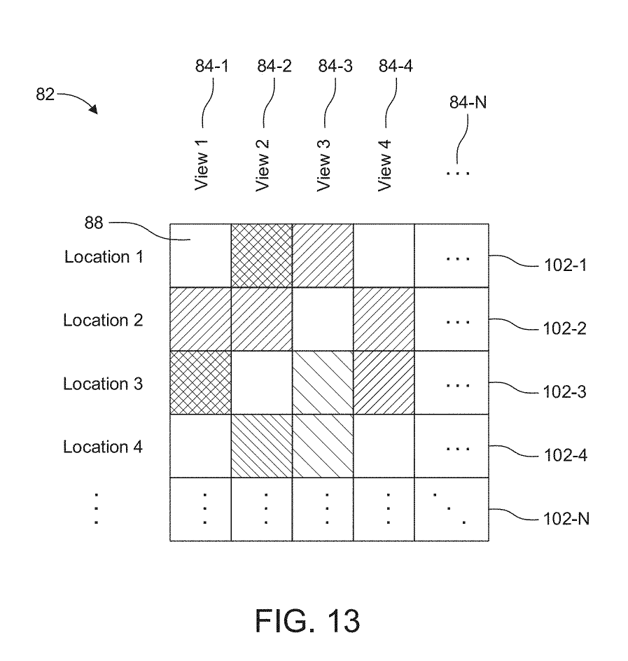

FIG. 13 shows a table that represents how the traveling pulse modality encodes the brightness information 88 for the pixels of views 84 via the light modulators 200. Each location (spatial column 102-1 through 102-N) in the waveguide 102 is represented as a row in the table and the views 84 of one or more frames 82 are represented as columns. The pixels of each view 84 are located at the intersection of each spatial column and view 84, and the brightness information 88 of each pixel is indicated by the shading of the corresponding square. A description of how the traditional strobe modality accomplishes the same objective with reference to the table is also provided for comparison.

A SAW modulator 200 of a holographic display system 10 is tasked with recreating the exemplary pattern of brightness information 88 in the table. In one example, for the traveling pulse modality, the controller module 60 first accesses the leftmost column, with label “View 1” for view 84-1. The controller module 60 directs the RE control circuit 25 to send a modulated RF signal 15 that induces a pulse of the SAW signals 140 in the waveguide 102 that is appropriate to encode the view 84-1 for that that column, and additionally sends control signals to the light modulator 30 to have bright light, then dim light, then no light, then bright light, and so on as the pulse 140 passes through locations 1, 2, 3, 4 (spatial columns 102-1 through 102-4) and to 102-N. After that pulse 140 has completed propagating, the controller module 60 induces a new pulse of the SAW signals 140 which is appropriate to the next column (“View 2”), and additionally controls the light modulator 30 as appropriate for the brightness information 88 for the pixels of view 84-2.

The controller module 60 iterates through all columns until the final column is processed, repeats as necessary until it is time to access the next frame 82, and then repeats the process again. In one example, with 4 km/s speed of sound, 3 cm long waveguide 48, 60 Hz video rate, and 100 different columns of views 84 per frame 82, the controller module 60 can cycle through all the columns as many as 22 times each within a single display frame. In another example, the controller module 60 could process the brightness information 88 by iterating through each column 22 times before processing the next column (e.g. processing the brightness information 88 for View 1 84-1 22 times, then processing the brightness information 88 for View 2 84-2 22 times, etc)

In contrast, a SAW modulator using the traditional strobe modality recreates this entire pattern every time the strobe light modulator 30 turns on, and this is executed once per transit time of the SAW signals.

FIGS. 14 and FIGS. 15A and 15B show possible embodiments for the light modulators 30 in the holographic display systems 10, though the light modulators 30 can take many forms. In examples, because the SAW modulators 200 are likeliest to be built from lithium niobate (LiNbO3), it is convenient to build the light modulators 30 from the same material platform and possibly integrate the modulators onto the same substrates 120, in which the SAW modulators are implemented.

In FIG. 14, a light modulator 30 is based on Y-junction Mach-Zehnder interferometer.

In general, the light modulator 30 comprises an input waveguide 208, which is preferably a single mode waveguide. This waveguide has been formed in a lithium niobate substrate, which could be the same substrate 120 as the modulators 200. The input waveguide 208 branches between a first arm 210 and a second arm 212. These two arms later merge into the output waveguide 214. In the illustrated embodiment, there are electrodes 21 on the first arm 210.

Depending on the voltage difference applied to the two metal electrodes 21, the transmission to the SAW modulator(s) 200 can vary from near 100% to near 0%. In more detail, the electric field generated by the electrodes 21 causes a phase shift in the corresponding first arm 210 relative to the second arm 212. This leads to constructive and destructive interference in the output waveguide 214. Optionally, a phase shifter can be included on the other arm of the interferometer.

One advantage of this light modulator 30 is that it is relatively broadband, so the same voltage setting could potentially be used for red, green, and blue light, for example.

FIG. 15A. shows another embodiment of a light modulator 30 that is based on 2×2 Mach-Zehnder switches 59, and FIG. 15B shows more detail for one of the switches 69 in FIG. 15A.

The switches 59 can be arranged into a tree or branching arrangement as shown in FIG. 15A. An advantage of this approach is that potentially very little light is wasted; for example, in a mostly-dark scene with a few bright spots, the intensity of the laser optical source 40 can be lowered, and the tree of switches can be adjusted to send most of the source light signals to the appropriate SAW modulator and its spatial rows at the appropriate times.

In more detail, in the illustrated embodiment, a first level switch 59-1 receives the input optical signal from the optical source 40. This first level switch 59-1 divides and controls the division of the input optical signal between two waveguides to two second level switches 59-2-A and 59-2-B. In turn, these second level switches 59-2-A and 59-2-B divide their received light between four third level switches 59-3-A, 59-3-B, 59-3-C, and 59-3-D. The various output waveguides 214-1, 214-2 . . . 214-8 then provide the input optical signals 101 to either groups of SAW modulators 200 or individual SAW modulators 200 of the display system 10.

FIG. 15B shows one possible implementation for the switches 59 shown in FIG. 15A.

More detail, each switch 59 is implemented as a Mach-Zehnder interferometer fabricated in a lithium niobate substrate, which could be the same substrate 120 as the SAW modulators 200. Specifically, two input waveguides 208-1, 208-2 receive input light and then merge at a combiner 216, before dividing again between the first arm 210 and the second arm 212.

As before, the first arm includes two electrodes 21. After the electrodes, the first arm 210 and the second arm 212 combine and then divide again into two output waveguides 214-1 and 214-2. By controlling the voltage applied to the electrodes 21, the phase shift in the first arm 210 can be controlled to thereby control the amplitude of the optical signal appearing on the two output arms 214-1, 214-2.

Comparing the embodiments of the light modulator 30 in FIGS. 14 and 30-2 in FIGS. 15A/15B, the brightness of the laser optical source 40 for light modulator 30-1 depends on the brightest spatial row 104, whereas the brightness of the laser optical source 40 for light modulator 30 depends on the average row.

The precise timing of the laser optical source 40 amplitude modulation provided by the light modulator 30 and controlled by the controller module 60 should be synchronized to the RF drive circuitry 25. The timing system may account for subtle factors like frequency-dependent speed of sound as the pulses travel, frequency-dependent time offset (e.g. from chirped IDTs 100 which effectively emit different pulses from different locations), and temperature-dependent speed of sound.

Each light modulator 30 typically operates by controlling the voltage of a certain metal electrode lead 21. Typically, the voltage needs to change each 50-500 nanoseconds (specifically, the desired spatial resolution, divided by the propagation velocity of the SAW signals 140). This is true even when applying very short laser pulses to the SAW signals as in the traveling pulse modality, since the pulse shuttering can happen at the (common) laser source 40, rather than at the individual light modulators 30.

A holographic display system 10 might contain hundreds or thousands of these light modulators 30-1/30-2, which must be individually controlled to convey scene-specific information. Through well-known techniques such as time-multiplexing and latching, only one or a few signal lines of the controller module 60 can pass digital or analog signals to each of hundreds of light modulators 30-1/30-2. Each light modulator 30-1/30-2 can store either just the present voltage level, or can store an array of voltage levels to be cycled through repeatedly.

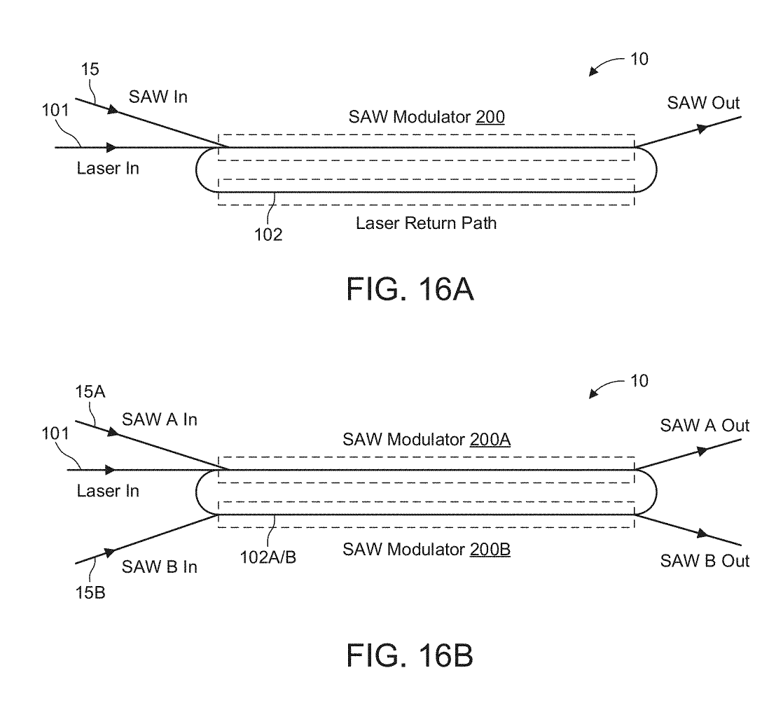

FIGS. 16A and 16B show different embodiments of a “racetrack laser” for improving power efficiency in the holographic display systems 10.

In FIG. 16A, an optical waveguide of the system 10 is looped into a “racetrack” configuration, where the light signals 101 make multiple passes in the same direction through the SAW modulator 200. In one example, the racetrack configuration of the waveguide is an obround configuration, which is generally a plane shape with two semicircles connected by parallel lines tangent to their endpoints. In another example, the waveguide is configured to enable the light signals to continue in a different direction.

This increases the fraction of the light diffracted by the SAW modulator 200. Note that there are no SAW modulators 200 in the return path of the laser optical source 40. While this configuration can be applied to all the embodiments of the holographic display system 10 described hereinabove and can operate under all wave propagation cancellation modalities, the racetrack configuration works especially well for the traveling pulse modality and within the single-pixel SAW modulator embodiment. This is because the single-pixel SAW modulator embodiment of the holographic display system 10 and any of the previous holographic display systems 10 that apply the traveling pulse modality generally have short light-SAW modulator interaction lengths, and thus generally only a small fraction of the light is outcoupled in a single pass.

The low numerical aperture (NA) of these waveguides 102 could limit the turn radius in a SAW modulator 200. Although at ‘some’ radius this will be possible it may be worth mentioning that end optical interconnects/mirrors or some such optical element may be required to recirculate the light in a real device,

FIG. 16B, the return path of the laser optical source 40 in FIG. 16A is instead replaced with a second SAW modulator 200B. The initial SAW modulator 200A and second SAW modulator 200B can be driven with RF signals 15A and 15B, respectively. This configuration can operate with the traveling pulse modality if the controller module 60 applies the RF signals 15A and 15B to the IDTs 110 of the SAW modulators 200A/200B in a time-multiplexed fashion, such that pulses of SAW signals 22A and 22B are not excited within SAW modulators 200A and 200B at the same time. Modulated and diffracted light signals 162A and 162B are emitted from the exit faces of the SAW modulators 200A and 200B. However, this configuration typically operates in a more straightforward fashion with the other embodiments and synchronization modalities.

Additionally and/or alternatively, a second laser optical source 40 input can be applied to the system 10 that transmits light signals 101 in a counterclockwise fashion in FIG. 16B. In one implementation, the waveguide racetrack could be patterned on the top of the substrate 120 of the SAW modulator 200, or the return path could go through the other side of the SAW modulator 200. The SAW signals 140 could also travel in the opposite direction to the direction portrayed.

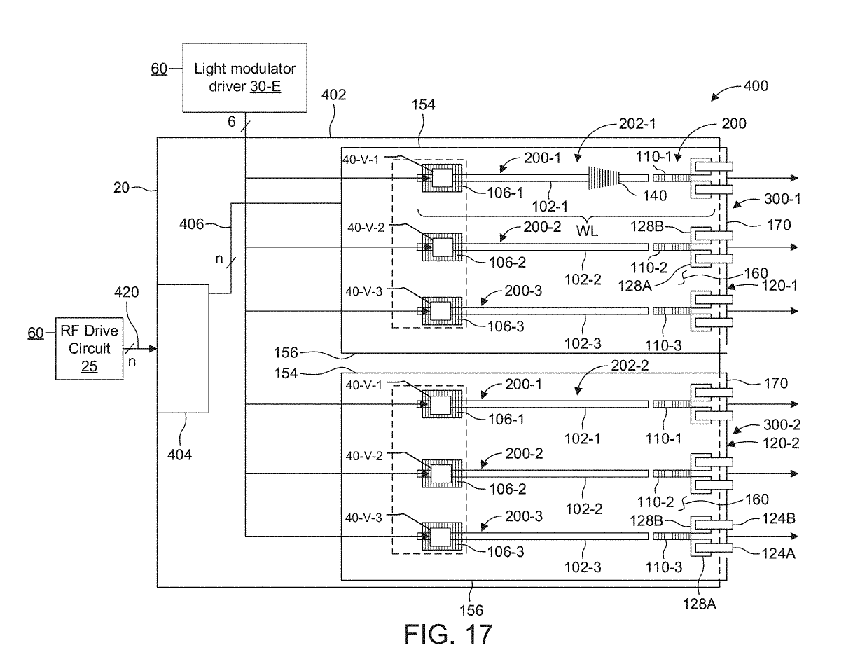

FIG. 17 shows yet another possibility that involves integrating one or more light emitting chips on the SAW substrates 120. These chips could be semiconductor laser diodes or light emitting diodes (LED). one example, the lasers are vertical cavity surface emitting lasers (VCSELs) 40-V. Thus, there is a separate, integrated light source for each waveguide 102 of each SAW modulator 200 of the display system 10.

Here, a separate VCSEL chips 40-V-1, 40-V-2, 40-V-3 are bonded to each grating input coupler 106 on the SAW substrates 120 of each light field generator devices 300-1 and 300-2. These VCSELs generate light that is coupled into the guided mode of the respective waveguide 102.

Thus, in this example, the light modulations is performed electronically by an electrical drive light modulator 30-E. Each of these laser or LEI) light emitting chips together function as the optical source 40. Then, the input lights to each SAW modulator is controlled by modulating the drive current of each laser or LED via the controller module 60.

While this invention has been particularly shown and described with references to preferred embodiments thereof, it will be understood by those skilled in the art that various changes in form and details may be made therein without departing from the scope of the invention encompassed by the appended claims.

What is claimed is:

1. A light field projection system, comprising:
an array of surface acoustic wave (SAW) modulators for projecting a light field;
an optical source generating light; and
a directional switch for dividing the light among the SAW modulators of the array.

2. The system of claim 1, wherein the directional switch divides the light for two or more groups of SAW modulators.

3. The system of claim 1, wherein the directional switch divides the light into four or more groups of SAW modulators.

4. The system of claim 1, wherein the direction switch provides light to different groups of the SAW serially in time.

5. The system of claim 1, wherein the directional switch divides the light for two or more groups of SAW modulator, the different groups being associated with distinct quadrants of the array of SAW modulators or interlaced groups of SAW modulators.

6. The system of claim 1, wherein the directional switch comprises one or more Mach-Zehnder interferometers.

7. A light field generation method, comprising:
generating light;
dividing the light; and
delivering the light to an array of surface acoustic wave (SAW) modulators for projecting a light field.

8. A light field projection system, comprising:
an array of surface acoustic wave (SAW) modulators for projecting a light field;
a light modulator for generating light signals for the SAW modulators that encode brightness information for different views.

9. The system of claim 8, further comprising a radio frequency (RF) drive circuit that generates the same RF signal for multiple SAW modulators.

10. The system of claim 9, wherein the RF signal determines the views.

11. The system of claim 9, wherein a duty cycle of the RF signal is less than 50%.

12. The system of claim 9, wherein a duty cycle of the RF signal is less than 25%.

13. The system of claim 8, further comprising a radio frequency (RF) drive circuit that generates the same RE signal for all SAW modulators of the system.

14. The system of claim 8, wherein the light signals are pulsed signals.

15. The system of claim 8, wherein the light signals are amplitude-modulated continuous wave signals.

16. The system of claim 8, further comprising a directional switch for dividing the light among the SAW modulators of the array.

17. A light field generation method, comprising:
generating light signals for an array of SAW modulators that encode brightness information; and
generating RF signals for the array of SAW modulators that encode views.

18. A light field generation system, comprising one or more acousto-optic modulators, such as SAW modulators, in which scene-specific information is conveyed in optical signals provided by light modulators to the acousto-optic modulators.

19. An acousto-optic modulator for a light field generation having a continuous waveguide for light re-circulation.

20. An acousto-optic modulator as claimed in claim 19, wherein the waveguide is oblong.

21. A SAW modulator, including:
a SAW substrate; and
one or more light emitting chips bonded to the SAW substrate.

22. A modulator as claimed in claim 21, wherein the light emitting chips are semiconductor laser diodes.

23. A modulator as claimed in claim 21, wherein the light emitting chips are light emitting diodes.

24. A modulator as claimed in claim 21, further comprising one or more gratings on the SAW substrate to couple light from the light emitting chips into one or more waveguides in the SAW substrate.
